(19) United States
(12) Patent Application Publication
(10) Pub. No.: US 2023/0247480 A1
(43) Pub. Date: Aug. 3, 2023

(54) METHOD AND SYSTEM FOR MANAGING NETWORK SLICES IN A COMMUNICATION NETWORK

(71) Applicant: SAMSUNG ELECTRONICS CO., LTD., Suwon-si (KR)

(72) Inventors: Ashok Kumar NAYAK, Bangalore (IN); Varini GUPTA, Bangalore (IN)

(21) Appl. No.: 18/162,094

(22) Filed: Jan. 31, 2023

(30) Foreign Application Priority Data
Feb. 1, 2022 (IN) 202241005416
Dec. 21, 2022 (IN) 202241005416

(51) Int. Cl. H04W 28/06; H04W 76/10

(52) U.S. Cl. CPC H04W 28/06; H04W 76/10

(57) ABSTRACT

The disclosure relates to a 5G or 6G communication system for supporting a higher data transmission rate. Embodiments of present disclosure relates to methods and network system for managing network slice in communication network. Management entity of network system detects UEs having inactive sessions and releases the inactive sessions for UEs. Management entity transmits notification to UEs and to AMF entity of network system indicating release of inactive sessions. Management entity also transmits a request to AMF entity requesting deregistration of UEs having inactive sessions. Further, AMF entity identifies presence of any active sessions for UEs through other management entities for access type corresponding to UEs. AMF entity upon identifying absence of active sessions, deregisters network slice for UEs having inactive sessions. Thereafter, NSACF entity of network system updates parameters associated with network slice for managing network slice. Thus, the present disclosure aids in avoiding wastage of resources of the network slice.

### CROSS-REFERENCE TO RELATED APPLICATION

This application is based on and claims priority under 35 U.S.C. § 119 to Indian Provisional Patent Application No. 202241005416, filed on Feb. 1, 2022, and Indian Non-Provisional Patent Application No. 202241005416, filed on Dec. 21, 2022, in the Indian Intellectual Property Office, the disclosure of which is incorporated by reference herein in its entirety.

### BACKGROUND

### 1. Field

The present subject matter is related in general to network slicing in communication network, but not exclusively, the present subject matter relates to a method and system for managing a network slice in a communication network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

During, Third Generation Partnership Project (3GPP) release fifteen, a concept of “Network Slicing” was introduced, which allows telecom service providers to deploy an exclusive network for a customer (e.g., MVNO, Enterprise) or service (e.g., eMBB, URLLC, mMTC), consisting of multiple network functions designed specifically to support specialized services. A set of such network functions is called “Network Slice”, identified using S-NSSAI (Single Network Slice Selection Assistance Information) in a 3GPP network.

These slices are characterized by a set of both standard and proprietary attributes as defined by a “slice template”. GSMA defines a “Generic Network Slice Template” (GST) which provides standardized slice attributes for a set of services supported by 3GPP. Two of the attributes defined by GST are “Number of Terminals” and “Number of Sessions”. Attribute “Number of Terminals” describes the maximum number of terminals (UEs) that may use the network slice simultaneously. Similarly, attribute “Number of Sessions” describes the maximum number of (PDU) sessions that may use the network slice simultaneously. These are important inputs in network planning, as operators need to make sure that the resources, they provide for the network slice are sufficient to handle the capacity specified by these attributes.

Further, to enforce these attributes, 3GPP Release-17 defines a functional entity “Network Slice Admission Control Function (NSACF)” which monitors and controls the number of UEs/sessions registered to a network slice. The NSACF is configured with the maximum number of UEs per network slice and is expected to be consulted (by AMF) while admitting a UE to the network. Similarly, NSACF is configured with the maximum number of sessions per network slice and is expected to be consulted (by AMF or SMF) while activating a PDU session. In 3GPP terminology, “Number of Terminals” may refer to “Number of UEs” or “Number of Registrations” per access-type. Similarly, “Number of Sessions” may refer to “Number of PDU Sessions”.

As specified in 3GPP TS 23.501 (Release-17), the NSACF controls (i.e., increases or decreases) the current number of UEs registered for a network slice so that it does not exceed the maximum number of UEs allowed to register with that network slice.

At present, a UE may register an S-NSSAI and then use that S-NSSAI to make PDU session establishment by invoking an application. However, after the successful establishment of the PDU session (PDN in EPC), there may be no downlink packet for the UE or there may be no traffic exchanged between the UE and the network for the same PDU session (PDN connection in EPC), and it may become idle. This may impact other UEs which may be waiting to use the slice for the PDU session (PDN connection) but because threshold might have been exceeded for PDU count, request of these UEs may be rejected by SMF (SMF+PGW−C in EPC). Similarly, these UEs may be indirectly consuming the same network slice for which AMF (SMF+PGW−C in EPC) has already updated UEs count and there may not be any capacity available for new UEs to use this slice. Hence, being rejected while requesting to use the same slice from the network.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for managing a network slice in a communication network. The method comprises detecting one or more User Equipment (UEs) of a plurality of UEs having one or more inactive sessions. The plurality of UEs is associated with a network slice of a plurality of network slices in a communication network. The method comprises releasing the one or more inactive sessions for the one or more UEs upon detection. The method comprises transmitting a notification to the one or more UEs indicating release of the one or more inactive sessions. The method comprises transmitting a notification indicating release of the one or more inactive sessions of the one or more UEs and a request for deregistering the network slice corresponding to the one or more inactive sessions for the one or more UEs to an Access and Mobility Management Function (AMF) entity of the network system, for managing the network slice.

In an embodiment, the present disclosure relates to a method for managing a network slice in a communication network. The method comprises receiving a notification from a management entity of the network system indicating release of one or more inactive sessions of one or more User Equipment (UEs) and a request for deregistering a network slice of a plurality of network slices in a communication network corresponding to the one or more inactive sessions for the one or more UEs, The notification and the request are received by the AMF upon detecting the one or more UEs of a plurality of UEs associated with the network slice having one or more inactive sessions. The method comprises identifying access types associated with the one or more UEs and presence of at least one active session for the one or more UEs through other management entities in the network system for the corresponding access types to the one or more UEs. Thereafter, the method comprises performing deregistration of the network slice for the one or more UEs, on identifying an absence of the at least one active session for the one or more UEs for the corresponding access types through the other management entities, for managing the network slice.

In an embodiment, the present disclosure relates to a network system for managing a network slice in a communication network. The network system comprises a management entity configured to detect one or more User Equipment (UEs) of a plurality of UEs having one or more inactive sessions. The plurality of UEs is associated with a network slice of a plurality of network slices in a communication network. The management entity may be configured to release the one or more inactive sessions for the one or more UEs upon detection. The management entity may be configured to transmit a notification to the one or more UEs indicating release of the one or more inactive sessions. The management entity may be configured to transmit a notification indicating release of the one or more inactive sessions of the one or more UEs and a request for deregistering the network slice for the one or more UEs to an Access and Mobility Management Function (AMF) entity of the network system. Further, the network system may comprise the AMF entity configured to identify access types associated with the one or more UEs and presence of at least one active session for the one or more UEs through other management entities in the network system for the access types corresponding to the one or more UEs. The AMF entity is configured to perform deregistration of the network slice for the one or more UEs, on identifying an absence of the at least one active session for the one or more UEs for the corresponding access types through the other management entities, for managing the network slice.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 shows an exemplary environment of a communication network for managing a network slice in the communication network, in accordance with some embodiments of the present disclosure;

FIG. 2a shows a detailed block diagram of a management entity for managing a network slice in the communication network, in accordance with some embodiments of the present disclosure;

FIG. 2b shows a detailed block diagram of an Access and Mobility Management Function (AMF) entity for managing a network slice in the communication network, in accordance with some embodiments of the present disclosure;

FIG. 3a illustrates a sequence diagram for managing a network slice in the communication network, in accordance with some embodiments of present disclosure;

FIG. 3b illustrates a sequence diagram for managing a network slice in the communication network, in accordance with some embodiments of present disclosure;

FIG. 4a illustrates a flowchart showing exemplary methods for managing a network slice in the communication network, in accordance with some embodiments of present disclosure; FIG. 4b illustrates a flowchart showing exemplary methods for managing a network slice in the communication network, in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Present disclosure relates to methods and a network system for managing a network slice in a communication network. Generally, one or more UEs register to a network slice and establish PDU sessions for communicating. The PDU sessions are utilised for different network services such as data transfer, calling, browsing and the like. However, after registering, if there is no data transfer, the one or more UEs may become idle/inactive. Thus, impacting other UEs from registering to the network slice and establishing PDU sessions, as the UEs and PDU session count may have exceeded for the network slice. To overcome the above problem, the present disclosure manages the network slice by releasing and deregistering inactive PDU sessions and UEs, respectively. The network system may comprise a management entity for detecting UEs having inactive PDU sessions. The management entity upon detecting UEs having inactive PDU sessions may release the inactive PDU sessions and request AMF entity of the network system to de-register the UEs. The AMF entity may check if the UEs include any active PDU sessions through other management entities. The AMF entity may de-register the UEs if no active PDU sessions are detected. Thereafter, the AMF entity may de-register the network slice for the UEs and manage the network slice. Thus, the present disclosure reduces wastage of resources such as the network slice by updating parameters of the network slice.

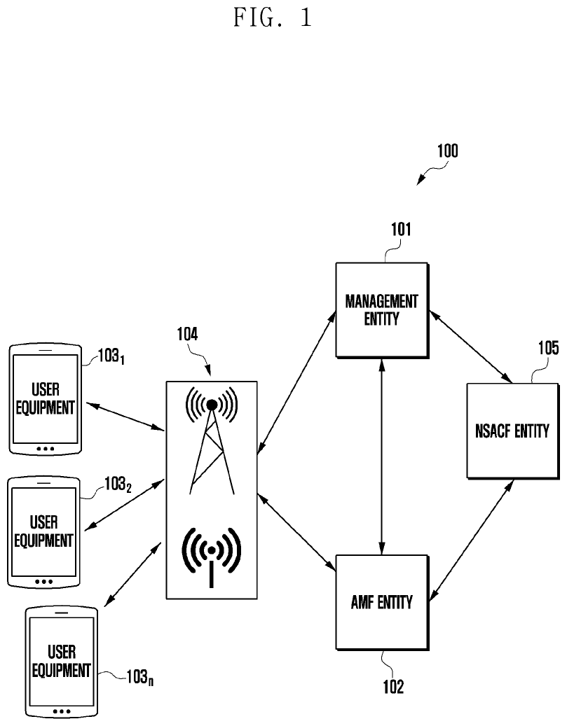

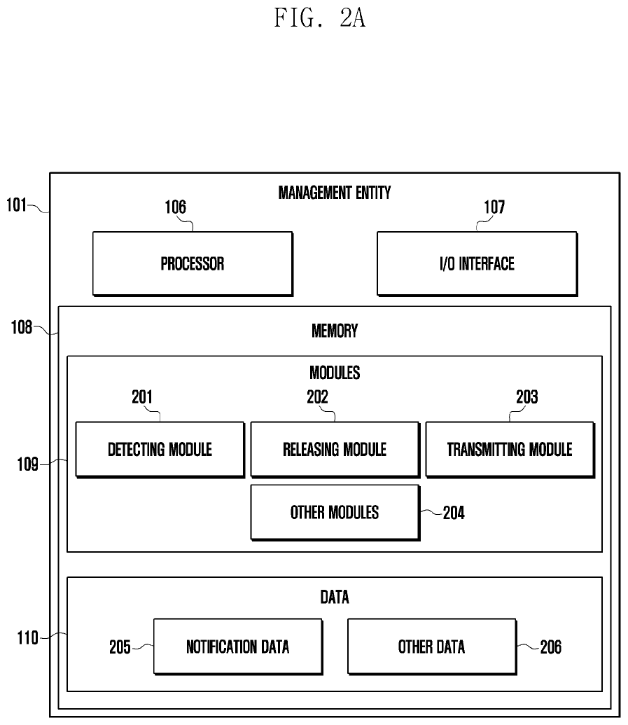

FIG. 1 shows an exemplary environment 100 for managing a network slice in a communication network. The environment 100 may include a network system comprising a management entity 101 and an AMF entity 102 associated with a Base Station (BS) or a wireless network 104, a UE 103₁, a UE 103₂ UE 103ₙ (herein after referred as plurality of UEs 103) and a Network Slice Admission Control Function (NSACF) entity 105. The plurality of UEs 103 is connected to the base station or the wireless network 104 for communicating with each other. The plurality of UEs 103 may be any device used directly by an end-user for communication. The plurality of UEs 103 may include, but is not limited to, a mobile phone, a smart phone, and the like. In an embodiment, the base station (3GPP access)/the wireless network (non-3GPP access) 104 may serve as a central connection point for the plurality of UEs 103 for establishing communication. The base station 104 may be responsible for managing radio resources for cells, and for handling radio link protocols with the plurality of UEs 103. The base station 104 may also performs other functions such as mobility management, handover, authentication, and the like. Further, a network slice may be assigned to each of the plurality of UEs 103 for performing one or more applications. The one or more applications may include, but is not limited to, retail shipping application, gaming application, and the like. In an embodiment, the network slice is utilised for splitting all resources along data path into multiple sets, each of which is optimized for specific UEs or use cases. In an embodiment, to utilise the resources of the network slice, the entities of the network system may interact with each other. For instance, the management entity 101, the AMF entity 102, the NSACF entity 105 and the plurality of UEs 103 may interact with each other for registering, de-registering UEs and releasing sessions utilizing the network slice. The management entity 101 may be, but is not limited to, a Session Management Function (SMF) entity, a Packet Data Network Gateway-Controller (PGW-C), and the like. The SMF entity may be a control function that manages user sessions including establishment, modification, and release of sessions in a 5G network. Similarly, the SMF and PGW-C controls the establishment, modification, and release of sessions in a 4G network. Further, the AMF entity 102 manages connection and mobility management of the plurality of UEs 103 while forwarding session management requirements to the SMF. The NSACF entity 105 manages count of the plurality of UEs 103 and the sessions for the network slice in the network system.

Consider the plurality of UEs 103 is associated with a network slice of a plurality of network slices in the communication network for performing one or more services. The one or more services may include, but is not limited to, browsing, calling, and the like. The plurality of UEs 103 may have established one or more PDU sessions with the network slice for data transfer. For example, consider the plurality of UEs 103 may have established one or more PDU sessions for browsing i.e., for data transfer. However, after a certain period of time there may be no data transfer and thus, the one or more PDU sessions may be inactive/idle. As such, the management entity 101 may be configured to detect one or more UEs of the plurality of UEs 103 having the one or more inactive PDU sessions. For example, consider there are five UEs that have established the one or more PDU sessions and two UEs have inactive PDU sessions. That is, there is no data transfer for the two UEs. In such case, the management entity 101 may detect the two UEs having the inactive PDU sessions. Further, the management entity 101 may release the inactive PDU session associated with the one or more UEs from the plurality of UEs 103. For instance, in the above example, the PDU session associated with the two UEs. Thereafter, the management entity 101 may transmit a notification to the one or more UEs. The notification may be a message that indicate that the inactive PDU sessions of the two UEs have been released due to no data transfer. Further, the management entity 101 may transmit another notification (i.e., a message) to the AMF entity 102 of the network system. The notification may indicate the release of the inactive PDU sessions of the one or more UEs. The notification may also include a request that indicates deregistering the network slice corresponding to the inactive PDU sessions for the one or more UEs.

Further, once the AMF entity 102 receives the notification from the management entity 101 after the release of the inactive PDU sessions, the AMF entity 102 may be configured to identify access type associated with the one or more UEs. Also, the AMF entity 102 may identify if there are any active PDU sessions for the one or more UEs through other management entities for the access types. The access type may include, but is not limited to, 3GPP access, non-3GPP access, and the like. For example, in this case, the access type of the one or more UEs may be either 3GPP access type or non-3GPP access type. Further, the AMF entity 102 may perform de-registration of the network slice for the one or more UEs, on identifying an absence of the active PDU session for the one or more UEs for the 3GPP access type and the non-3GPP access type. Further, the NSACF entity 105 may be configured to receive a notification (i.e., a message) from the management entity 101 and the AMF entity 102 for updating one or more parameters of a plurality of parameters associated with the network slice. The NSACF entity 105, upon receiving the notification, may be configured to manage the network slice based on the deregistration of the one or more UEs and the release of the inactive PDU sessions. That is, the NSACF entity 105 may update count of UEs and the PDU sessions established with the network slice upon deregistration of the one or more UEs and release of the inactive PDU sessions. The one or more parameters may include, but not limited to, number of UEs connected to the network slice and number of PDU sessions established with the network slice. The number of UEs connected to the network slice and the number of PDU sessions established with the network slice is reduced upon deregistering the one or more UEs and releasing the inactive PDU sessions, respectively. For example, in the above example, upon deregistering the two UEs, the count of UEs may be updated to three. Similarly, upon release the inactive PDU sessions of the two UEs, the count of PDU sessions may be updated to three. Further, the AMF entity 102 may be configured to provide a deregistration notification to the one or more UEs. The deregistration notification may include information regarding deregistering of the network slice for the one or more UEs and a predefined time period for re-registering the one or more UEs to the network slice. That is, the deregistration notification may indicate that the one or more UEs have been deregistered due to inactive PDU sessions and also a predefined time period such as, one hour after which the two UEs may re-register to the network slice.

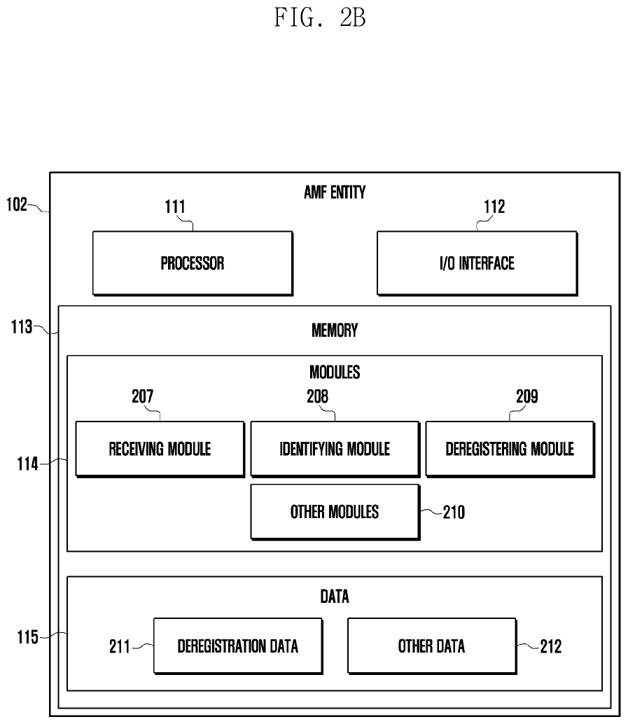

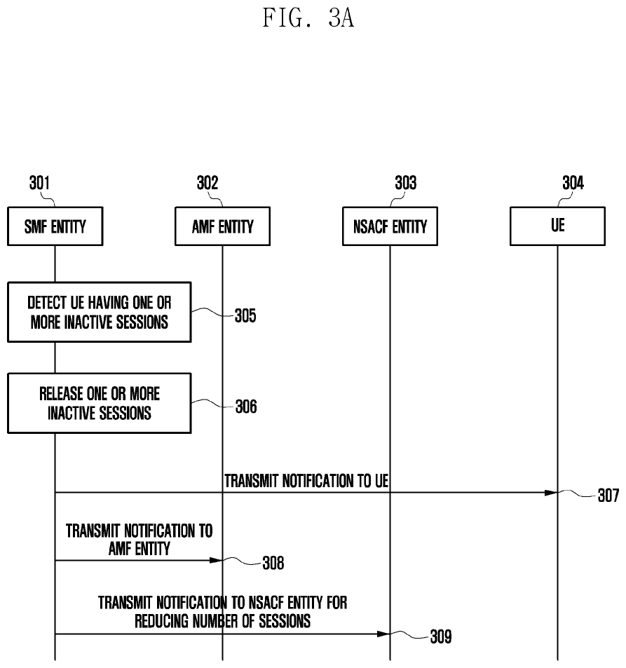

FIG. 2a shows a detailed block diagram of a management entity for managing a network slice in the communication network, in accordance with some embodiments of the present disclosure.

Data 110 and one or more modules 109 in the memory 108 of the management entity 101 is described herein in detail.

In one implementation, the one or more modules 109 may include, but are not limited to, a detecting module 201, a releasing module 202, a transmitting module 203, and one or more other modules 204, associated with the management entity 101.

In an embodiment, the data 110 in the memory 108 may include notification data 205, and other data 206 associated with the management entity 101.

In an embodiment, the data 110 in the memory 108 may be processed by the one or more modules 109 of the management entity 101. The one or more modules 109 may be configured to perform the steps of the present disclosure using the data 110, for managing the network slice in the communication network. In an embodiment, each of the one or more modules 109 may be a hardware unit which may be outside the memory 108 and coupled with the management entity 101. In an embodiment, the one or more modules 109 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

The notification data 205 may include a message indicating release of one or more inactive sessions which is transmitted to the one or more UEs of the plurality of UEs 103 and to the AMF entity 102. In an embodiment, the notification data 205 may also include a message indicating a request for deregistering the network slice for the one or more UEs.

The other data 206 may store data, including temporary data and temporary files, generated by modules for performing the various functions of the management entity 101.

The detecting module 201 may detect the one or more UEs of the plurality of UEs 103 based on status of sessions. The one or more UEs may have one or more inactive sessions i.e., there is no data transfer for the one or more sessions established by the one or more UEs. The one or more inactive sessions may include, but is not limited to, PDU sessions, PDN sessions, and the like. For example, the one or more UEs of the plurality of UEs 103 may have established one or more sessions for performing actions such as calling, browsing, and so on. Once the actions are completed, the one or more sessions may become idle/inactive as there is no more data transfer and thus, the one or more inactive sessions of the one or more UEs is to be detected and released.

The releasing module 202 may release the one or more inactive sessions for the one or more UEs upon detecting the one or more inactive sessions. The transmitting module 203 may transmit the notification to the one or more UEs. For example, once the one or more inactive sessions are released, the transmitting module 203 informs the one or more UEs that the one or more inactive sessions are released. In an embodiment, the transmitting module 203 also informs the reasons to the one or more UEs for release of the one or more inactive sessions. Further, the transmitting module 203 may transmit the notification to the AMF entity 102. The transmitting module 203 informs the AMF entity 102 regarding the release of the one or more inactive sessions and also requests the AMF entity 102 to deregister the network slice for those one or more UEs. Further, the transmitting module 203 may transmit the notification to the NSACF entity 105 informing the NSACF entity 105 to update the number of sessions established with the network slice upon release of the one or more inactive sessions.

The one or more modules 109 may also include other modules 204 such as, an updating module, to perform various miscellaneous functionalities of the management entity 101. The updating module may update the number of sessions established with the network slice based on the notification. It will be appreciated that such modules may be represented as a single module or a combination of different modules.

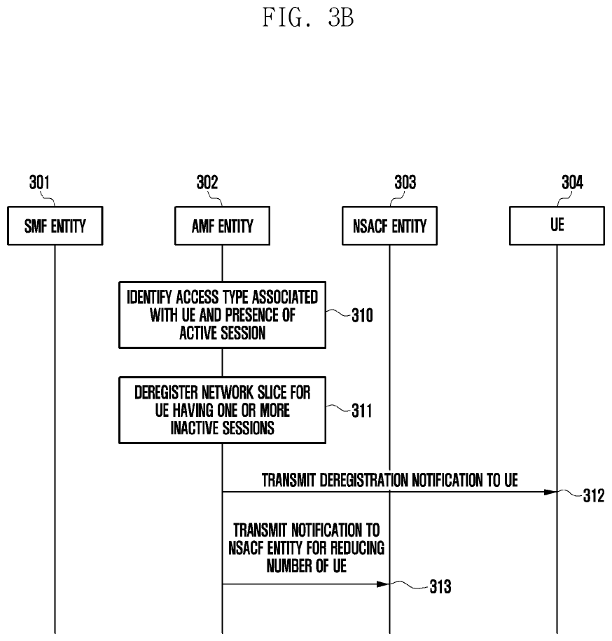

For instance, consider FIG. 3a that illustrates a SMF entity 301, an AMF entity 302, a NSACF entity 303 and a plurality of UEs 304. Consider that a network slice that is controlled by the NSACF entity 303 may be associated with the plurality of UEs 304. Consider the plurality of UEs 304 may be ten, in this scenario. The network slice may include a threshold of ten UEs and eight PDU sessions established with the network slice. Consider eight UEs out of the ten UEs have established respective (eight) PDU sessions with the network slice. Thus, if a ninth UE decides to establish a PDU session with the network slice, the PDU session cannot be established, as the network slice has reached its threshold for the number of PDU sessions. In such a scenario, at step 305 as shown in FIG. 3a, the SMF entity 301 may detect one or more UEs having one or more inactive PDU sessions. Upon detecting presence of the one or more inactive PDU sessions, at step 306, the SMF entity 301 may release the one or more inactive PDU sessions for the one or more UEs. For example, five UEs out of the eight UEs that have established the PDU sessions, may have inactive PDU sessions, as there is no data transfer. In such a case, the inactive PDU sessions of the five UEs may be released. Further, at step 307, the SMF entity 301 may transmit a notification to the one or more UEs 304 and indicate that the release of the one or more inactive PDU sessions. At step 308, the SMF entity 301 may transmit a notification to the AMF entity 302. The notification may indicate release of the one or more inactive PDU sessions of the one or more UEs and a request for deregistering the network slice for the one or more UEs. Similarly, at step 309, the SMF entity 301 may transmit a notification to the NSACF entity 303 for updating one or more parameters of a plurality of parameters associated with the network slice. The one or more parameters comprises number of PDU sessions or PDN connections established with the network slice. The one or more parameters is updated by reducing the number of PDU sessions or PDN connections established with the network slice. That is, for example, the five inactive PDU sessions may be released and the NSACF entity 303 updates the number of PDU sessions from eight to three. Thus, allowing the ninth UE to establish a PDU session with the network slice.

FIG. 2b shows a detailed block diagram of an AMF entity for managing a network slice in the communication network, in accordance with some embodiments of the present disclosure.

Data 115 and one or more modules 114 in the memory 113 of the AMF entity 102 is described herein in detail.

In one implementation, the one or more modules 114 may include, but are not limited to, a receiving module 207, an identifying module 208, a deregistering module 209, and one or more other modules 210, associated with the AMF entity 102.

In an embodiment, the data 115 in the memory 113 may include deregistration data 211, and other data 212 associated with the AMF entity 102.

In an embodiment, the data 115 in the memory 113 may be processed by the one or more modules 114 of the AMF entity 102. The one or more modules 114 may be configured to perform the steps of the present disclosure using the data 115, for managing the network slice in the communication network. In an embodiment, each of the one or more modules 114 may be a hardware unit which may be outside the memory 113 and coupled with the AMF entity 102. In an embodiment, the one or more modules 114 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

The deregistration data 211 may include a message indicating release of one or more inactive sessions of the one or more UEs of the plurality of UEs 103. In an embodiment, the deregistration data 211 may also include a message indicating a request for deregistering the network slice for the one or more UEs. In an embodiment, the deregistration data 211 may also include a message regarding deregistering of the network slice for one or more UEs and a predefined time period for re-registering to the network slice.

The other data 212 may store data, including temporary data and temporary files, generated by modules for performing the various functions of the AMF entity 102.

The receiving module 207 may receive the notification from the transmitting module 203 of the management entity 101 in FIG. 2a. The notification indicates that the one or more inactive sessions of the one or more UEs are released and a request to deregister the network slice for the one or more UEs. In an embodiment, the receiving module 207 may receive the notification upon release of the one or more inactive sessions. For example, in FIG. 2a, when the one or more inactive sessions are released, the transmitting module 203 of the management entity 101 may send the notification to the receiving module 207 of the AMF entity 102 for deregistering the network slice. Further, the identifying module 208 of the AMF entity 102 may identify the access type of the one or more UEs and check if there are any active sessions for the one or more UEs through other management entities. For example, the identifying module 208 may identify the access type of the one or more UEs as either 3GPP or non-3GPP and that the one or more UEs do not have any active sessions. In case of 3GPP access type or non-3GPP access type, the deregistering module 209 of the AMF entity 102 may deregister the network slice for the one or more UEs for managing the network slice. Alternatively, if the identifying module 208 identifies that the one or more UEs have active sessions through other management entities, then the network slice is not deregistered for the one or more UEs. Further, the deregistering module 209 may provide deregistration notification to the one or more UEs. The deregistration notification may indicate that the network slice is deregistered, and a predefined time period is indicated to re-register to the network slice. For example, once the network slice is deregistered for the one or more UEs, the one or more UEs are informed regarding the deregistration and also provided with the predefined time period for re-registering to the same network slice. The predefined time period may be in hours, days, and the like. In an embodiment, the predefined time period may be determined by an operator based on their requirement. The deregistering module 209 of the AMF entity 102 may also transmit the notification to the NSACF entity 105. The deregistering module 209 may inform the NSACF entity 105 to update the number of UEs connected with the network slice upon deregistration.

The one or more modules 114 may also include other modules 210 such as, an updating module and transmitting module to perform various miscellaneous functionalities of the AMF entity 102. The updating module may update the number of UEs connected with the network slice based on the notification. The transmitting module may transmit the notification to the NSACF entity 105 for updating the number of UEs. It will be appreciated that such modules may be represented as a single module or a combination of different modules.

For instance, consider FIG. 3b that illustrates the SMF entity 301, the AMF entity 302, the NSACF entity 303 and the plurality of UEs 304. At step 310, the AMF entity 302 receives a notification from the SMF entity 301 and identifies access type of the one or more UEs and presence of active sessions. That is, the AMF entity 302 checks if the one or more UEs is associated with a 3GPP access or a non-3GPP access and if there is any other active PDU session through other SMF entities. In an embodiment, if there are active PDU sessions, the AMF entity 302 does not deregister the one or more UEs. At step 311, the AMF entity 302 may perform deregistration of the network slice for the one or more UEs, on identifying absence of the active PDU sessions for the one or more UEs. For example, in the above scenario of FIG. 3a, the SMF entity 301 detected five UEs out of eight UEs with inactive PDU sessions and the SMF entity 301 released the inactive PDU sessions of the five UEs. The SMF entity 301 also transmits the notification to the AMF entity 302 for registering the five UEs. The AMF entity 302 upon receiving the notification checks if there are any active PDU sessions for the five UEs through other SMF entities. If the AMF entity 302 does not find any active PDU sessions for the five UEs, the AMF entity 302 deregister the network slice for the five UEs. Returning to FIG. 3b, at step 312, the AMF entity 302 may provide a deregistration notification to the one or more UEs. The deregistration notification comprises information regarding deregistering of the network slice for one or more UEs and the predefined time period for re-registering to the network slice. In an embodiment, the deregistration of the network slice comprises removing the network slice from an allowed Network Slice Selection Assistance Information (NSSAI) associated with the network slice and placing the network slice in a rejected NNSAI associated with the network slice. At step 313, the AMF entity 302 may transmit a notification to the NSACF entity 303 for updating one or more parameters of a plurality of parameters associated with the network slice. The one or more parameters comprises number of UEs connected to the network slice. The one or more parameters is updated by reducing the number of UEs connected to the network slice upon deregistration. For example, consider the above example, where the network slice is deregistered for the five UEs. The NSACF entity 303 may update the number of UEs from ten to five. Thus, allowing new UEs to connect to the network slice.

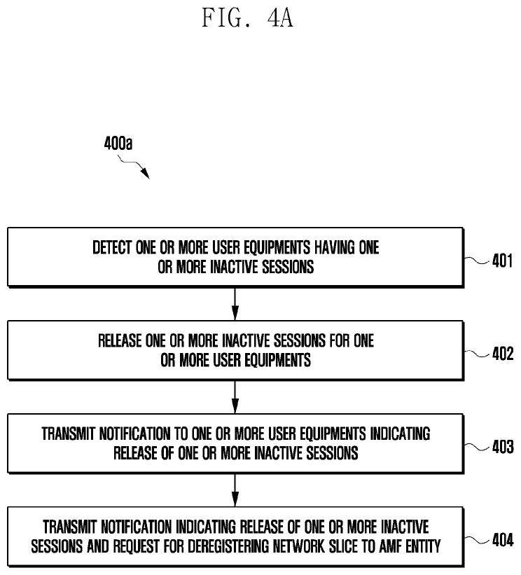

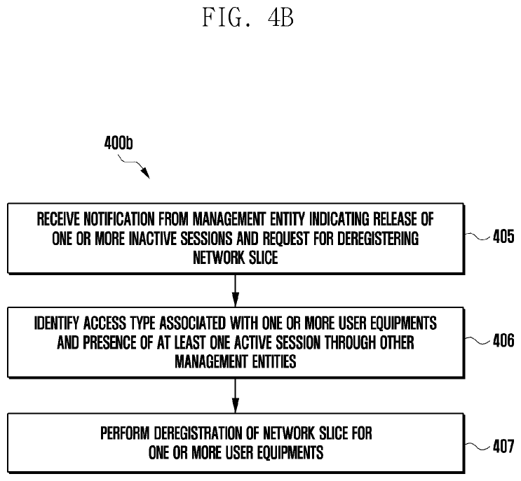

FIGS. 4a and 4b illustrate flowcharts showing exemplary methods for managing a network slice in a communication network, in accordance with some embodiments of present disclosure.

As illustrated in FIG. 4a, the method 400a may include one or more blocks for executing processes in the network system. The method 400a may be described in the general context of computer executable instructions. Generally, computer executable instructions can include routines, programs, objects, components, data structures, procedures, modules, and functions, which perform particular functions or implement particular abstract data types.

The order in which the method 400a are described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, detecting, by the management entity 101, one or more UEs of a plurality of UEs having one or more inactive sessions. The plurality of UEs is associated with a network slice of a plurality of network slices in a communication network.

At block 402, releasing, by the management entity 101, the one or more inactive sessions for the one or more UEs upon detection. Particularly, upon releasing the one or more inactive sessions, the management entity 101 transmits a notification to a Network Slice Admission Control Function (NSACF) entity of the network system for updating one or more parameters of a plurality of parameters associated with the network slice. The one or more parameters comprises number of PDU sessions or PDN connections established with the network slice. Further, updating the one or more parameters associated with the network slice comprises reducing the number of PDU sessions or PDN connections established with the network slice.

At block 403, transmitting, by the management entity 101, a notification to the one or more UEs indicating release of the one or more inactive sessions.

At block 404, transmitting, by the management entity 101, a notification indicating release of the one or more inactive sessions of the one or more UEs and a request for deregistering the network slice corresponding to the one or more inactive sessions for the one or more UEs to an Access and Mobility Management Function (AMF) entity 102 of the network system, for managing the network slice.

In an embodiment, FIG. 4b illustrates a flowchart showing exemplary methods for managing a network slice in a communication network.

At block 405, receiving, by the AMF entity 102, a notification from the management entity 101 of the network system. The notification indicates release of the one or more inactive sessions of the one or more UEs and a request for deregistering the network slice for the one or more UEs. The notification and the request are received by the AMF entity 102 upon detecting the one or more UEs of the plurality of UEs 103 having one or more inactive sessions.

At block 406, identifying, by the AMF entity 102, access types associated with the one or more UEs and presence of at least one active session for the one or more UEs through other management entities in the network system for the corresponding access types to the one or more UEs.

At block 407, performing, by the AMF entity 102, deregistration of the network slice for the one or more UEs, on identifying an absence of the at least one active session for the one or more UEs for the corresponding access types through the other management entities, for managing the network slice.

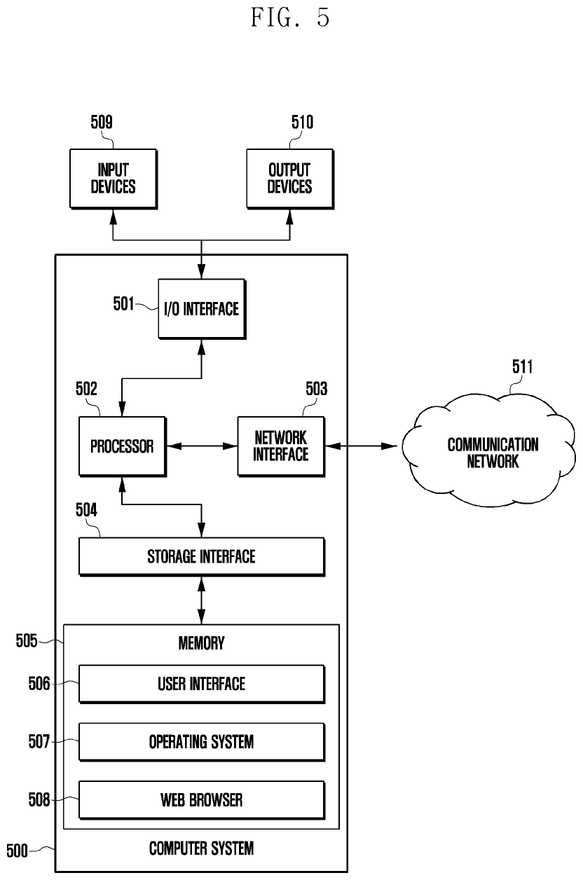

FIG. 5 illustrates a block diagram of an exemplary computer system 500 for implementing embodiments consistent with the present disclosure. In an embodiment, the computer system 500 is used to implement the management entity 101. In an embodiment, the computer system 500 is used to implement the AMF entity 102. The computer system 500 may include a central processing unit (“CPU” or “processor”) 502. The processor 502 may include at least one data processor for executing processes in Virtual Storage Area Network. The processor 502 may include specialized processing units such as, integrated system (bus) controllers, memory management control units, floating point units, graphics processing units, digital signal processing units, etc.

The processor 502 may be disposed in communication with one or more input/output (I/O) devices 509 and 510 via I/O interface 501. The I/O interface 501 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices 509 and 510. For example, the input devices 509 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 510 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 may consist of the management entity 101 and the AMF entity 102. The processor 502 may be disposed in communication with the communication network 511 via a network interface 503. The network interface 503 may communicate with the communication network 511. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 511 may include, without limitation, a direct interconnection, local area network (LAN), wide area network (WAN), wireless network (e.g., using Wireless Application Protocol), the Internet, etc. Using the network interface 503 and the communication network 511, the computer system 500 implementing the management entity 101

may communicate with the AMF entity 102 and the NSACF entity 105 for managing the network slice in the communication network. In another embodiment, the computer system 500 implementing the AMF entity 102 may communicate with the management entity 101 and the NSACF entity 105 for managing the network slice in the communication network via the communication network 511. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 511 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data, such as, the data, variables, records, etc., as described in this disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™OS/2, MICROSOFT™ WINDOWS™ (XP™, VISTA™/7/8, 10 etc.), APPLE® IOS™, GOOGLE® ANDROID′, BLACKBERRY® OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure allows new UEs to connect to the network slice by deregistering UEs having inactive PDU sessions or PDN connections.

An embodiment of the present disclosure allows registered UEs to establish PDU sessions or PDN connections with the network slice by releasing the inactive PDU sessions or PDN connections.

An embodiment of the present disclosure reduces wastage of resources such as the network slice by managing the plurality of parameters of the network slice.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 4a and 4b show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method performed by an access and mobility management function (AMF) entity, the method comprising:
receiving, from a session management function (SMF) entity, an indication for releasing at least one protocol data unit (PDU) session, in case that to release the at least one PDU session for a terminal associated with a network slice is determined based on an inactivity;
identifying whether the terminal has at least one active PDU session for the network slice through other SMF entity; and
determining that the network slice is deregistered for the at least one PDU session in case that the terminal does not have the at least one active PDU session for the network slice through other SMF entity.

2. The method of claim 1, further comprising:
determining to remove the network slice from allowed network slice selection assistance information (NSSAI) associated with the network slice of the terminal.

3. The method of claim 1, wherein, in case that no data is transferred during a certain period of time, the at least one PDU session is identified as an inactive PDU session.

4. The method of claim 1, further comprising:
determining that the network slice is not deregistered for the at least one PDU session in case that the terminal has the at least one active PDU session for the network slice through other SWF entity.

5. A method performed by a session management function (SMF) entity, the method comprising:
determining to release at least one protocol data unit (PDU) session for a terminal associated with a network slice, in case that the at least one PDU session is an inactive PDU session; and
transmitting, to an access and mobility management function (AMF) entity, an indication for releasing the at least one PDU session,
wherein the network slice is deregistered for the at least one PDU session in case that the terminal does not have at least one active PDU session for the network slice through other SMF entity.

6. The method of claim 5, wherein the network slice is removed from allowed network slice selection assistance information (NSSAI) associated with the network slice of the terminal.

7. The method of claim 5, wherein, in case that no data is transferred during a certain period of time, the at least one PDU session is identified as the inactive PDU session.

8. The method of claim 5, wherein the network slice is not deregistered for the at least one PDU session in case that the terminal has at least one active PDU session for the network slice through other SMF entity.

9. An access and mobility management function (AMF) entity, comprising:
a transceiver; and
at least one processor configured to:
receive, from a session management function (SMF) entity via the transceiver, an indication for releasing at least one protocol data unit (PDU) session, in case that to release the at least one PDU session for a terminal associated with a network slice is determined based on an inactivity,
identify whether the terminal has at least one active PDU session for the network slice through other SMF entity, and
determine that the network slice is deregistered for the at least one PDU session in case that the terminal does not have the at least one active PDU session for the network slice through other SMF entity.

10. The AMF entity of claim 9, wherein the at least one processor is further configured to:
determine to remove the network slice from allowed network slice selection assistance information (NSSAI) associated with the network slice of the terminal.

11. The AMF entity of claim 9, wherein, in case that no data is transferred during a certain period of time, the at least one PDU session is identified as an inactive PDU session.

12. The AMF entity of claim 9, wherein the at least one processor is further configured to:
determine that the network slice is not deregistered for the at least one PDU session in case that the terminal has the at least one active PDU session for the network slice through other SW′ entity.

13. A session management function (SMF) entity, comprising:
a transceiver; and
at least one processor configured to:
determine to release at least one protocol data unit (PDU) session for a terminal associated with a network slice, in case that the at least one PDU session is an inactive PDU session, and
transmit, to an access and mobility management function (AMF) entity via the transceiver, an indication for releasing the at least one PDU session,
wherein the network slice is deregistered for the at least one PDU session in case that the terminal does not have at least one active PDU session for the network slice through other SMF entity.

14. The SMF entity of claim 13, wherein the network slice is removed from allowed network slice selection assistance information (NSSAI) associated with the network slice of the terminal.

15. The SMF entity of claim 13, wherein, in case that no data is transferred during a certain period of time, the at least one PDU session is identified as the inactive PDU session.

16. The SMF entity of claim 13, wherein the network slice is not deregistered for the at least one PDU session in case that the terminal has at least one active PDU session for the network slice through other SMF entity.
